(19) United States
(12) Patent Application Publication
(10) Pub. No.: US 2025/0117589 A1
(43) Pub. Date: Apr. 10, 2025

(54) Large Language Models for Predictive Modeling and Inverse Design

(71) Applicant: X DEVELOPMENT LLC, Mountain View, CA (US)

(72) Inventors: Julia Black Ling, Menlo Park, CA (US); Alberto Camacho Martinez, San Mateo, CA (US); David Andre, San Francisco, CA (US); Christopher Hahn, Palo Alto, CA (US)

(21) Appl. No.: 18/830,758

(22) Filed: Sep. 11, 2024

Related U.S. Application Data
(60) Provisional application No. 63/587,735, filed on Oct. 4, 2023.

(51) Int. Cl. G06F 40/30

(52) U.S. Cl. CPC G06F 40/30

(57) ABSTRACT

An inverse design system combines a large language model (LLM) with a task-specific optimizer, which includes a search function, a forward model, and a comparator. The LLM adjusts parameters of the optimizer's components in response to a design scenario. Then the optimizer processes the design scenario to produce design candidates. Optionally, the LLM learns from the design candidates in an iterative process. A stochastic predictive modeling system combines an LLM with input distributions and a forward model. The LLM adjusts one or more of the input distributions and/or the forward model in response to a forecast scenario. Then the forward model processes a sampling of the input distributions to produce a forward distribution. Optionally, the LLM informs the sampling process. Optionally, the LLM learns from the forward distribution.

### CROSS-REFERENCE TO RELATED APPLICATIONS

This application claims priority to and the benefit of the filing date of U.S. Provisional Application No. 63/587,735, filed Oct. 4, 2023, the entire disclosure of which is incorporated herein by reference.

### BACKGROUND

For many application areas, inverse design is an important workflow. In inverse design the goal is to search a multi-dimensional space, in which each dimension represents a controllable parameter and each point value represents an outcome, to find a combination of the controllable parameters that will yield a point value that satisfies a set of constraints or that maximizes an objective function. One challenge with inverse design is that it may not be clear what experiment or course of action to pursue in the workflow. For example, if a search space is high-dimensional with many parameters, an optimizer may not be able to try all potential candidates within an acceptable compute time. Thus, the optimizer may not be able to achieve its objectives for the specific problem at hand.

Stochastic predictive modeling is used to simulate processes that are probabilistic in nature. Example application areas include: transit times, climate risk, financial forecasting, power demand forecasting, insurance risk, and contagion spreading. Stochastic predictive modeling may employ Monte Carlo simulation, in which uncertain input parameters can have their probability distributions estimated based on historical data. Each individual distribution can be randomly sampled, and the samples can be propagated through a forward model. The forward model may be a physics-based or mechanistic simulation, an experiment, or a machine learning model. The sampling and propagation process is repeated to generate a final prediction distribution.

### BRIEF SUMMARY

The technology provides, among other things, solutions for certain problems that arise in the fields of inverse design and of stochastic predictive modeling. For example, the technology enhances stochastic modeling approaches in situations where historical data may not be representative of a given current situation, or where input parameters are interdependent, so that building a full probability distribution function (PDF) or joint probability distribution function (jPDF) may be important to fully represent the system, but the data to do so may not be available. As another example, the technology enables inverse design in situations where the design search space is high-dimensional, there is a lack of knowledge where to start searching, there is uncertainty as to what forward model to employ, and/or there is uncertainty as to how to assess the design candidates against the design target.

The technology applies a large language model (LLM) to the inverse design or stochastic modeling process. The LLM may be tailored by pre-training and/or fine-tuning on a specific corpus of information corresponding to the domain of interest, such as a particular technology space. Such tailoring of the LLM can involve interactions with a domain expert, who can provide useful insights into which combinations of parameters are likely to be successful and which may not be feasible. According to one aspect of the technology, the LLM can be employed in different phases of the optimization process, such as by adjusting initial seeds, adjusting likelihoods of taking or accepting optimization steps, informing which forward model(s) to use, etc. According to another aspect, the semantic understanding of the LLM can be used to adjust how the input parameters are sampled in order to guide the stochastic modeling process.

According to one aspect of the technology, a computer-implemented method for inverse design is provided. The method comprises: inputting a design scenario for an optimizer to a large language model; generating, by the large language model according to the design scenario, a set of rankings, weights or options for one or more aspects of the design scenario; adjusting a set of parameters of the optimizer according to the set of rankings, weights or options generated by the large language model; and running the optimizer with the adjusted set of parameters on the design scenario to generate one or more design candidates.

In an example, the optimizer is associated with a plurality of forward models. Here, the method includes generating the set of rankings or weights for one or more aspects of the design scenario include ranking or weighting each of the forward models, and running the optimizer includes selecting at least one of the forward models according to the ranking or weighting.

In another example, generating the set of rankings, weights or options for the one or more aspects of the design scenario includes tailoring the large language model according to a specific corpus of information corresponding to the design scenario. In this case, the tailoring may include performing active learning with the specific corpus of information. Alternatively or additionally, the tailoring may include performing active learning via a domain expert conversation.

According to another aspect of the technology, a processing system is configured to perform inverse design. The processing system comprises: memory configured to store one or more design candidates; and one or more processors operatively coupled to the memory. The one or more processors are configured to: input a design scenario for an optimizer to a large language model; generate, employing the large language model according to the design scenario, a set of rankings, weights or options for one or more aspects of the design scenario; adjust a set of parameters or generating a set of outputs of the optimizer according to the set of rankings, weights or options generated while employing the large language model; and run the optimizer with the adjusted set of parameters on the design scenario to generate the one or more design candidates.

In one example, the optimizer is associated with a plurality of forward models; generation of the set of rankings, weights or options for one or more aspects of the design scenario includes ranking or weighting each of the forward models; and the optimizer is run to include selection of at least one of the forward models according to the ranking or weighting. In another example, generation of the set of rankings, weights or options for the one or more aspects of the design scenario includes the large language model being tailored according to a specific corpus of information corresponding to the design scenario. Here, the tailoring may include performance of active learning via a domain expert conversation. Alternatively or additionlly, the one or more design candidates may comprise a set of design candidates, and the processing system is further configured to rank or filter the set of design candidates.

According to another aspect of the technology, a computer-implemented method for stochastic predictive modeling is provided. The method comprises establishing one or more input distributions for a forecast scenario; establishing a forward model for the forecast scenario; inputting the forecast scenario to a large language model; informing, by the large language model according to the forecast scenario, a modification, weighting or ranking for at least one of the input distributions, a joint input distribution, or the forward model based on the forecast scenario; and based on the informing, running the forward model on the input distributions to generate a forward distribution. In some cases, the forward model may comprise a transformer model trained specifically to predict output distributions given the input distributions.

In one example, running the forward model includes sampling from the input distributions and applying the sampling to the forward model. In this case, the sampling may be informed by the large language model. In another case, a transformer model may replace the need for sampling. In a further example, informing the modification, weighting or ranking is done by shifting at least one of the one or more input distributions. Alternatively or additionally, informing the modification, weighting or ranking by the large language model includes the large language mode indicating a distribution type, one or more distribution parameters, or individual values of a probability distribution function.

According to yet another aspect of the technology, a processing system is configured to perform stochastic predictive modeling. The processing system comprises: memory configured to store at least one of a forecast scenario or a forward distribution; and one or more processors operatively coupled to the memory. The one or more processors are configured to: establish one or more input distributions for the forecast scenario; establish a forward model for the forecast scenario; input the forecast scenario to a large language model; inform, by employing the large language model according to the forecast scenario, a modification, weighting or ranking for at least one of the input distributions, a joint input distribution or the forward model based on the forecast scenario; and based on the inform the modification, run the forward model on the input distributions to generate the forward distribution. In an example, the forward model is run to includes sampling from the input distributions and application of the sampling to the forward model.

### BRIEF DESCRIPTION OF THE DRAWINGS

FIGS. 1A and 1B depict an inverse design process that utilizes an LLM, according to aspects of the technology.

FIG. 2 depicts an example of a Transformer-type neural network architecture that may be used in aspects of the technology.

FIG. 3 depicts a stochastic modeling process that leverages an LLM, according to aspects of the technology.

FIGS. 4A and 4B depict an example computer architecture in which the technology may be implemented.

FIGS. 5A and 5B are flow diagrams illustrating example methods according to aspects of the technology.

### DETAILED DESCRIPTION

### Overview

As mentioned, the technology resolves problems that, generally, are associated with uncertainties about the available information to be used for stochastic modeling or for inverse design. The technology utilizes LLMs for domain-specific tasks. An LLM is a machine learning neural network that can be trained on unlabeled text and image data sets to generate desired responses. LLMs may include millions or billions of parameters. The LLM may employ any type of neural network architecture that has been trained on a large text corpus so that it gains a semantic understanding of text, such as a Transformer-type approach.

An LLM may be pre-trained, or may be fine-tuned or re-trained on a domain-specific corpus, e.g., stock market and other financial data histories for a financial modeling task or optical physics articles and other documents for an optical inverse design task. The LLM can be prompted with a domain-specific question or a set of questions related to the task. The LLM may ask one or more clarifying questions about the prompt or about information that could be useful to answer the prompt. Then the LLM answers the prompt. The prompt may be revised, or a new prompt provided, to expand upon or clarify one or more aspects of the LLM's answer. The cycle can continue until the LLM's answer to the task is satisfactory. The LLM can then be applied to one or more aspects of the inverse design or stochastic modeling scenario.

There are various types of parameters associated with the technology. The LLM parameters (of which there may be millions or billions), are numeric weights arrayed in tensors that are used to weigh the input parameters and produce the output parameters. The input parameters for the LLM will depend on what the model is trained for. By way of example, in financial modeling, the choice of what stocks to include in the portfolio; in travel time prediction or cargo routing, the estimated traffic conditions along each route from source to destination, etc. Optimization parameters are another type of parameter. For instance, in simulated annealing optimizers, the optimization parameters can include a temperature schedule, directionality of mutations for the annealing, etc. Modeling parameters are yet another type. In a stochastic modeling situation, the modeling parameters may include a selection of forward model coefficients. In an approach discussed herein, the LLM can be used to inform the optimization parameters, the modeling parameters, and the input parameters.

### Tailoring

According to one aspect of the technology, an LLM can be tailored to a specific application. LLM tailoring can be done using one or more approaches. One approach involves fine-tuning the model. Here, a subset of the LLM parameters can be adjusted during training on a corpus of text, audio, and/or image data. This can include training only a few layers or using a low-rank approach (such as freezing pretrained model weights and/or low rank adaptation of large models (LORA)). Alternatively or additionally, the LLM may be fully pre-trained. Here, all LLM parameters can be adjusted as the LLM is trained on a new corpus of text, audio, and/or image data. Prompt engineering may also be applied, either separately or in addition to other techniques. With prompt engineering, extra information can be appended to an input prompt. For instance, example input/output pairs can be appended to the prompt. Retrieval Augmented Generation (RAG) can be used to add references to data corpuses to the prompts.

There are a number of options as to which data may be used for tailoring. For instance, data could be curated by a subject matter expert or based on an automated search query. One data set may comprise context-specific text-based documents that are associated with a given domain. Examples of such context-specific material include academic journal papers about a particular topic as well as a database of past designs and test results. Alternatively or additionally, tailoring can use in-context data from back and forth “conversations” between the LLM model and one or more domain experts. This approach can be expanded using data augmentation, where a given conversation with an expert user could be augmented to create semantically similar variations that will be used during tailoring.

Active learning is another approach that can be particularly beneficial for inverse design and stochastic modeling. In active learning, the LLM can identify an area of uncertainty where its training data may not support a high degree of confidence in its output for a given set of input parameters (e.g., the confidence falls below some threshold level, such as below 85%-90% confidence, or more or less). Upon determining that there is a low confidence in its response for a given input parameter combination or set of input parameter combinations, such as falling below a threshold, the LLM can query one or more users with a question about the input parameter combinations. The question is designed to reduce uncertainty in the LLM response for a set of input parameter combinations, model parameters, or optimizer parameters. The answer is used to further tailor the LLM, either through further fine-tuning/training or prompt engineering. The user(s) may be human subject matter experts. Note that the uncertainty could depend on the data. For example, the LLM could ask, “Is this a reliable data source to use to optimize X quantity?”

The active learning cycle can be iterative, with the LLM asking multiple rounds of questions and retraining after each round before asking the next set of questions. The retraining can include varying the weights of different LLM parameters. By way of example, for inverse design, the active learning may identify a set of parameters and ask whether the combination of parameters is feasible. For stochastic modeling, this approach can be used to obtain contextual information from the domain expert, such as to identify what might be different in the current situation from historical data. Additionally, tabular or quantitative data (e.g., product yield as a function of bioreactor parameters) could be translated to text-based data and used as training data. This quantitative data could include the results of a forward model. This could be done by prompting the LLM along the lines of “This combination of parameters produced a drug that was modeled to have an undesirable property that renders it unsuitable for a medical application.”

### Inverse Design

In inverse design, the goal is to find a combination of the controllable parameters that will yield target quantities of interest that satisfy a set of constraints and/or that maximize/minimize an objective function. There are a wide variety of applications where an inverse design approach can be particularly beneficial. The following are a few, non-limiting, examples.

One inverse design problem would be to design supply chain parameters to optimize profitability with a constraint on overall acceptable delay to market and on satisfying existing contracts. In supply chain optimization, there are numerous decisions around pricing, routing, and manufacturing that can impact the target properties of production cost, delays, and profit. In synthetic biology, there may be a target molecule for which microbial synthesis pathways are sought. Here, controllable parameters might include the microbe species, the bioreactor environmental conditions, and any gene edits. Another inverse design problem is to select the combination of microbe, bioreactor conditions, and gene edits to optimize yield for a target molecule. Yet another inverse design problem can be to design a component for a vehicle, airplane or ship, subject to constraints on aerodynamic, structural, and thermal performance, with minimized cost. Another inverse design problem involves electrochemical systems, where the free parameters include the electrode, electrolyte, and separator materials and layout and the objective function includes a combination of performance parameters.

In such cases, it is possible to use a forward model to predict the target properties as a function of the input properties based on existing quantitative and/or categorical data. This forward model may be a supervised machine learning model, such as a neural network, random forest, Transformer model or Gaussian process. The forward model could also be a simulation, mathematical model, experimental procedure, or production process. The forward model can be applied within an optimization loop to search the domain for the optimal combination of controllable parameters.

According to one aspect of the technology, the semantic understanding of an LLM, which may be fine-tuned, can be applied to one or more phases of an optimization for an inverse design problem. In particular, the LLM can be employed in one or more phases of the optimization process, such as by adjusting initial seeds or hyperparameters, adjusting the likelihoods of taking or accepting a particular optimization step, determining potential step options, selecting which candidate(s) to present to a user or otherwise output as a result, inform which forward model(s) to use, etc.

In this workflow, it may not always be straightforward to incorporate qualitative information and expert domain knowledge into the optimization loop. Domain experts can have useful insights into which combinations of parameters are most likely to be successful for a given application, and which might be impractical or otherwise unfeasible. There also may be text-based (or other) information that includes qualitative information on which combinations could make the most sense or least sense, such as which combination(s) meet a set of criteria.

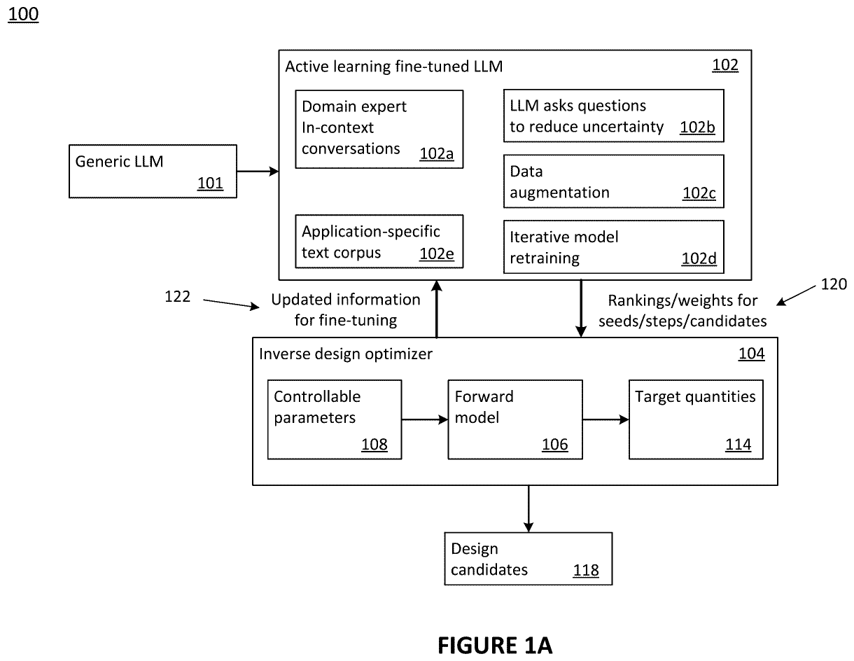

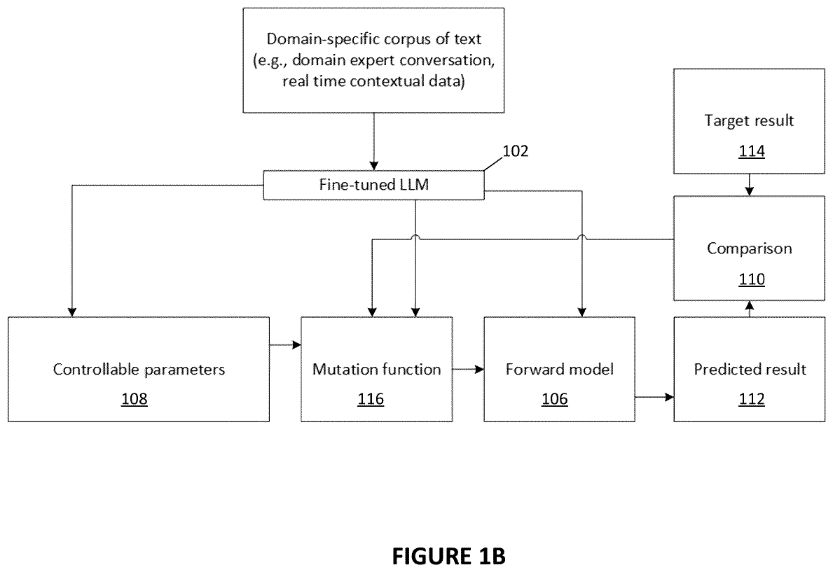

FIG. 1A and FIG. 1B depict an exemplary inverse design process 100 that utilizes an LLM 102, according to embodiments of the technology. The LLM may be fine-tuned or otherwise tailored, although this is not required. For instance, in this scenario a “generic” (e.g., pre-existing off the shelf) LLM 101 may be subject to active learning fine-tuning. For instance, domain expert in-context conversations (102a) and/or the LLM asking questions (102b) can be used to reduce uncertainty about its training data or about input parameters can be used for data augmentation (102c), such as auto-completion or guided search. The LLM may be retrained (102d) in an iterative model retraining approach. Alternatively or additionally, one or more application-specific text corpuses (102e) may be fed to the LLM as training data or may be embedded for Retrieval Augmented Generation, which can also be used in the tailoring process.

In the inverse design process 100, the LLM 102 interacts with an optimizer 104. As shown in this example, the optimizer 104 includes one or more forward model(s) 106, which is/are configured to produce a set of output values from a point in a design search space of controllable (input) parameters 108. Each forward model may be used to predict results 112 of the system to be evaluated, as a function of the input properties 108, based on existing quantitative or categorical data. By way of example, each forward model may be a supervised machine learning model, such as a neural network, random forest, Transformer, or Gaussian process. The forward model(s) also could be simulations, mathematical models, experimental processes, or production processes.

As shown by arrow 120, the LLM 102 provides the optimizer 104 with rankings or weights for seeds, steps, and/or design candidates used or produced by the optimizer. This can include the LLM 102 selecting which forward model 106 to try at different stages of the optimization process. And as shown by arrow 122, the LLM can receive from the optimizer updated information for additional fine-tuning of the LLM. That is, according to one aspect of the technology, the LLM can inform the optimizer and also can learn from the optimizer.

FIG. 1B shows an example optimization loop for the process in FIG. 1A, using the forward model(s) 106. Based on a comparator 110 comparing the forward model's predicted results 112 to target quantities 114 of a design scenario, the optimizer traverses the search space according to a search function (sometimes called a “mutation function”) 116. With each mutation, the optimizer can produce a suggested candidate 118 (see FIG. 1A). Some of these candidates may be evaluated by one forward model (e.g., a simulation or ML model) and others may be evaluated by another forward model (e.g., an experimental or production process). In some embodiments, the optimizer iterates from different search seeds, and/or iterates in different directions from a common search seed, to produce a plurality of design candidates 118.

The LLM 102 may interact with the optimizer 104 in a variety of ways. For example, the LLM 102 could be used to select or to adjust one or more features of the optimization (the optimization parameters). Optimization parameters can include the “prior” for the design search seed, the “direction” for searching starting from a given seed, the likelihood of accepting a given movement in the search space (e.g., a simulated annealing “temperature” or a learning rate), and/or the “loss function” that is used in the comparison 110 to assess how closely a predicted result 112 approximates the target quantities 114. The LLM may be queried directly for input or the optimization parameters could be set by evaluating metrics in the LLM's encoded space. The LLM may be queried once or more than once for any given combination of input parameters and optimization parameters.

For many optimization algorithms (e.g., genetic algorithms, gradient descent algorithms, etc.) that are used for inverse design, the optimizer 104 may start with seeds and then optimize by taking steps from those seeds (moving within the design search space). It may not always be apparent about which starting seed to select. The LLM approach discussed above can be used to suggest seeds. This could be done by one of (1) a direct prompt, (2) suggesting potential seeds to the LLM and assessing its agreement that those seeds could yield the properties of interest, or (3) looking at an agreement metric or semantic similarity metric between the combination of parameters and the target properties in the encoded space of the LLM. This could be done with a single query or with a set of multiple queries to the LLM. The LLM may also have access to a corpus of embedded documents to access via Retrieval Augmented Generation to augment these query prompts.

With regard to the search function 116, it may not always be obvious what experiment to try next or what direction to move in the design search space. For example, in part design, the process may involve changing the length of an automotive component or changing the material. In synthetic biology, there may be a change to a bioreactor parameter or microbial culture. In some optimization algorithms, these changes can be chosen randomly, while in others they may be chosen based on gradients and/or concepts of momentum. According to one aspect of the technology, the LLM can weight which directions to take steps in, and to adjust the probability of accepting those steps throughout the process. For example, a next move in the search space could be selected based on looking at the LLM's embedded space and seeing how similar the next move is to the target quantities 114, compared to how similar the current set of input parameters 108 is to the target quantities 114. Thus, the LLM can be used to guide the optimization hyperparameters, such as number of initial seeds, step size, temperature or the like. For example, the LLM could be queried, “Yes or no, are there many local minima for this objective?” If the LLM replies “Yes”, then the temperature and step size could be adjusted accordingly. For example, the LLM could be queried: “Which additive X, Y, or Z can be added to this recipe without decreasing its emulsification properties?” In another example, the LLM could be queried, “What are the related proteins to the current one under consideration?”

With regard to the forward model 106, the LLM can be used to identify which feed forward model(s) to apply, since such models may have different fidelities and/or costs. For example, there might be a full physics-based computational fluid dynamics model (CFD) that is computationally expensive and accurate. There may also be a less accurate and less computationally expensive machine learning model for the forward model. In addition or alternatively, there might also be a complete physical model test procedure involving a wind tunnel. The LLM could be asked to select an appropriate forward model for the given combination of input parameters and target quantities. The LLM could select which forward model makes sense to query at a given region of parameter space based on what the relative model uncertainties and costs are in that region.

The LLM could be used to check for consistency of a particular feed forward model, e.g., by checking alignment of the prediction of the model with correlations suggested by the LLM. The LLM also can check consistency between multiple forward models, can identify and ask questions based on inconsistencies. For example, the machine learning model might be a Gaussian process and the optimization loop could use simulated annealing to suggest optimal parameter combinations. These optimal parameter combinations could then be tested and the results could be used to retrain the machine learning model in an active training loop. An example optimization loop is discussed below.

With regard to the loss function or comparison 110 of FIG. 1B, the LLM could be used to rank or filter design candidates based on semantic similarity metrics (for example, distance metrics) in the encoded space between the candidates and the target properties. For example, if a user or forward model has previously given information that a given combination of parameters is not feasible, then the LLM can be finetuned on that information. Subsequent candidates that have that same or similar combination of parameters can be selected against and not shown to the user. The LLM can be queried, “Is this combination of parameters (X, Y, X) feasible?” Thus, the LLM could replace the optimizer entirely in certain cases, such as where there are several input parameter options and the LLM is used to rank them from most to least likely based on some agreement metric (e.g., Euclidean distance in encoded space, cross-encoder similarity score, etc.) between the input parameters and the target, and this ranked list is provided back to the user.

For example, in supply chain optimization, if the target is “optimize production of a new shoe”, and there are five options for manufacturing site, the five options could be encoded and their distance from the encoding of the target could be evaluated. These distance metrics could be used to help determine what candidates to select or filter out.

In some aspects of the technology, the LLM can learn from output of a forward model. When a candidate is evaluated, the results of that evaluation could be provided to the LLM, either by fine-tuning the LLM again on a corpus that includes a text version of the result (e.g., “Production of shoes was 11000 per week when production was located in Santiago”) or by including this information in the prompt for in-context learning.

The following discussion provides several exemplary use cases.

### Synthetic Biology

Assume a user wants to optimize a microbial synthesis pathway for a given protein. There may be a choice of dozens of parameters (or more or less) that can be varied (e.g., target microbe, gene edits, reactor configuration, reactor flow rates and environmental conditions, feed medium). In this scenario, it may be desirable to find the combination of parameter settings to maximize yield of the protein given constraints on cost. There may be several model options for determining the yield, including a machine learning (ML)-based model, a physics-based model, and the option to run a physical experiment in their lab reactor. In this case, the ML based model is computationally inexpensive but has a low accuracy below a desired threshold, the physics-based model has moderate computational cost that is greater than that of the ML model and also has moderate accuracy greater than the ML model, which meets the desired threshold. In contrast, the experimental option is the most computationally expensive but is also the most accurate, exceeding the desired threshold and being higher than the physics-based model.

In this scenario, the user has domain expertise in synthetic biology and has some knowledge on what parameter settings are feasible or are otherwise promising. The user also has access to a corpus of relevant documents for this synthetic biology problem. The corpus of documents is provided to the system, which uses the corpus to fine-tune an off-the-shelf LLM for this use case. Once trained, the user can ask the system to provide the combination of parameters that will optimize yield of the protein given cost constraints.

Based on this query, the LLM asks the user about specific regions of the parameter space in which it has identified the highest uncertainty to determine their feasibility. This could be done by asking the LLM directly about areas of uncertainty, and/or by using semantic embeddings to find areas where there is a large distance between a given query and any text in the training or domain-specific corpus. It could also be done by using metrics of the LLM confidence in its answers. The user or another source of information such as a domain expert provides an answer, which is used to further fine tune the LLM in an active learning loop. As a result of this process, the fine-tuned LLM provides one or more initial seeds for the optimizer and suggests which forward model should be used for each step in the optimizer. The fine-tuned LLM may also weight which steps the optimizer takes and accepts (such as in 120 of FIG. 1A). Based on this, the optimizer is able to provide suggested parameter combinations for evaluation by the forward models, with direction from the LLM on which forward model to use for each parameter combination (such as in 122 of FIG. 1A). The LLM may be iteratively re-finetuned based on batches of results from the forward models. The LLM can also be iteratively re-queried to update the optimizer settings. Accordingly, the system generates suggested parameters to the user for optimal protein yield, who can provide more expert feedback to the system for further fine-tuning of the LLM as necessary.

### Supply Chain Optimization

In another scenario, assume a user wants to streamline their company's supply chain for production of shoes. They can vary parameters including, e.g., lace vendor, eyelet vendor, uppers material and uppers material vendor, soles material and soles material vendor, assembly location. The goal may be to identify a combination of parameters that maximizes per-unit margin. The user can estimate margin based on one of several market pricing models in combination with one of several production cost models. The models are fitted to data for different types of shoes, different projections of raw material and labor costs, and various customer demographics. In this scenario, the user may have retained a consultant who has domain expertise in shoe production. Additionally, the user has access to industry trade journals that discuss challenges and solutions for materials sourcing and final assembly. The input to the system includes text from selected articles in the trade journals (the user may curate the articles to further fine-tune the fine-tuning).

The consultant may confer with the system in a Q&A format after the system has integrated the trade journal articles into its training data for tailoring. According to this scenario, the LLM may ask the user (or the consultant) about specific regions of parameter space in which it has the highest uncertainty to determine their feasibility. The answer is used to further fine tune the LLM in an active learning loop. The fine-tuned LLM is able to identify and provide one or more initial seeds for the optimizer and to suggest which forward model should be used for each step in the optimizer. The fine-tuned LLM may also weigh which steps the optimizer takes and accepts (such as in 120 of FIG. 1A). Based on this, the optimizer provides suggested parameter combinations for evaluation by the forward models, with direction from the LLM on which forward model to use for each parameter combination. The LLM may be iteratively finetuned based on batches of results from the forward models (such as in 122 of FIG. 1A). The LLM can be iteratively re-queried to update the optimizer settings. The system is thus able to provide suggested parameters to the user for the highest achievable per-unit margin.

### General Transformer Approach

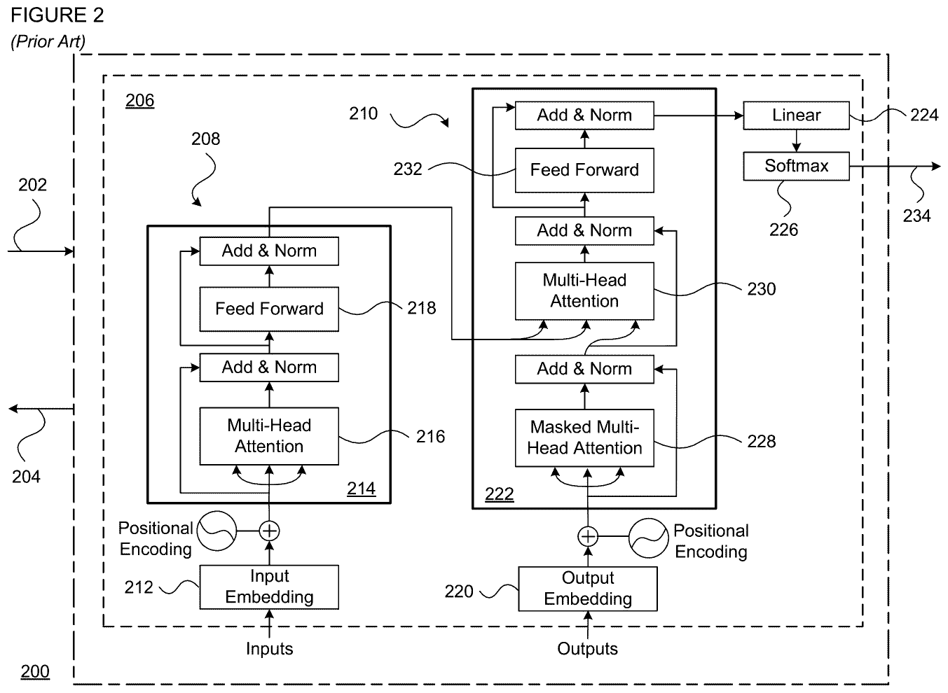

The techniques discussed herein may employ any suitable type(s) of neural networks including recurrent neural networks (RNNs) or Long Short-Term Memory (LSTM) networks. Another such configuration includes a self-attention architecture, e.g., a Transformer neural network encoder-decoder architecture. An example of a Transformer-type architecture is shown in FIG. 2, which is based on the arrangement shown in U.S. Pat. No. 10,452,978, entitled “Attention-based sequence transduction neural networks”, the entire disclosure of which is incorporated herein by reference.

System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured to receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Stochastic Modeling

As noted above, according to another aspect of the technology, the semantic understanding of the LLM can be used to guide a stochastic modeling process. This can include adjusting how the input parameters are sampled. It also can include filling-in unknown priors. It can also include training a LLM to replace the full stochastic model, taking input distributions as inputs, discretized by percentiles, and outputting a probability distribution function discretized by percentiles. Stochastic modeling is used to simulate processes that are probabilistic in nature, including power consumption forecasts, financial forecasts, risk forecasts, agricultural yield forecasts, and disease transmission forecasts. For predictive modeling, the prediction starts from inferred or assumed distributions. Stochastic modeling often uses Monte Carlo techniques to model the distribution of the output of a model given uncertainties in the inputs.

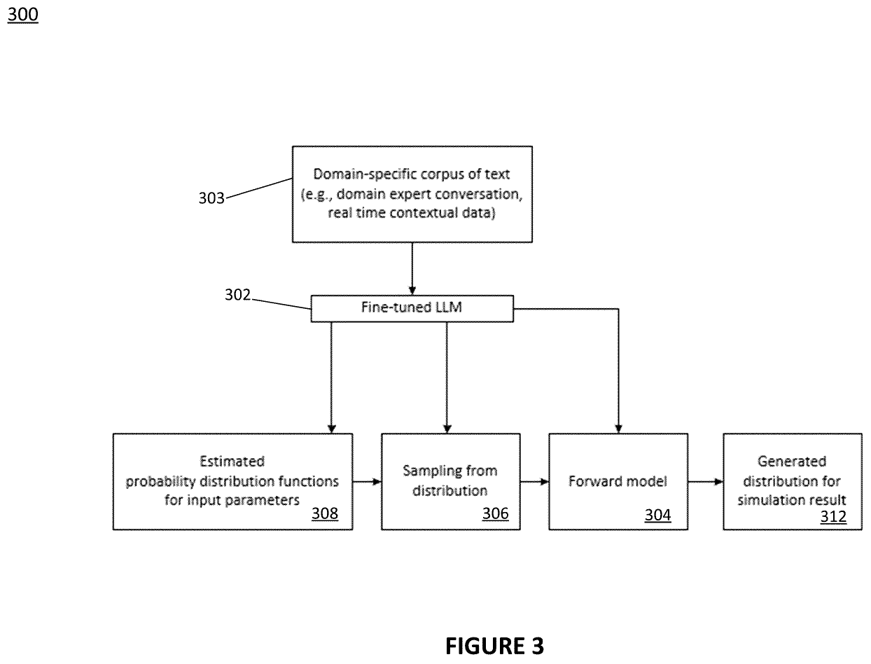

FIG. 3 depicts a stochastic modeling process 300 according to aspects of the technology that leverages an LLM 302 to address a forecast scenario. In some implementations, the LLM 302 may be tailored, e.g., by training on domain expert conversations, a text corpus, and or real-time context data-collectively, “tuning information” 303. As shown, a forward model 304 obtains samples 306 from one or more input distributions (block 308). The input distributions, which can comprise estimated probability distributions for the input parameters, may be selected according to the forecast scenario, e.g., for a transit-oriented forecast scenario the input distributions may include road maintenance, traffic accidents, weather events, and commute schedules whereas for an epidemiological forecast scenario the input distributions may include hygiene compliance, weather patterns, and vaccine availability. The forward model 304 then operates on the sampling of the input distributions 308 to generate a distribution for a simulation result (forward distribution) 312. The input distributions 308 and the forward distribution 312 each may be multi-variate and/or multi-dimensional.

The uncertain input parameters may have their probability distributions estimated based on historical data. One or more individual distributions are sampled at 306 and the samples are propagated through the forward model 304. By way of example, the forward model may be a physics-based or mechanistic simulation, or a machine learning model. The sampling can be done through random sampling from the distribution or through a quadrature-based approach. This sampling and propagation process may be repeated one or more times to generate a final prediction distribution.

The LLM 302 may be employed to inform the input distributions 308 as shown in FIG. 3. For example, regarding the input distributions 308, historical data is not always representative of a given current or future situation. Also, at least some of the input parameters may be interdependent. In such cases, independently sampling the input probability distributions may not be accurate. Moreover, building a full joint probability distribution function (PDF) may not be feasible based on historical data availability. However, experienced operators, text corpuses, or domain experts may have information on how certain conditions could impact the input parameters. However, it may not be straightforward for those operators to directly add their domain knowledge into the stochastic simulation.

In order to address such issues, a tailored LLM may be employed to make more effective assumptions for the unknown priors. The tailored LLM may be used to inform joint distributions or covariances between two or more inputs. By way of example, the LLM could be used to assess covariance between various input parameters, e.g., lost luggage and flight delays. In another example, the LLM could be asked, “how likely is weather to impact disease transmission?” A joint PDF could be informed by the LLM, e.g., according to assessments of encoded similarity metrics or LLM outputs between a range of textual statements. Based on the results, the covariance matrix between various input parameters could be adjusted so that instead of sampling different input parameters independently, they could be drawn from a joint distribution. A full joint probability distribution function (jPDF) could also be informed by the LLM through assessments of encoded similarity metrics or LLM outputs between a range of statements (e.g., “How much is 30 degree weather to increase disease transmission?” “How much is 40 degree weather going to increase disease transmission?” “How much is 50 degree weather going to increase disease transmission?” etc.).

Prompting the LLM for values of unknown priors, and/or for a list of unknown priors for which it would be helpful to have values, can enhance the predictive modeling task. Generally, the LLM can be used to create or inform an input probability distribution function. For example, if there is insufficient historical data to construct a probability distribution function, the LLM could be asked, “what is the likelihood of port congestion impacting both Port of Vancouver and Port of Seattle during this voyage?” To this end, LLMs can be provided with additional contextual information. For example, “There is currently a labor strike expected at Port of Seattle to commence in the next 2 weeks.” As other examples, a transit time estimation system could get real time information about weather conditions, traffic conditions, or large events in the area. For example, a contagion modeling system could get real time information on public gatherings, hospitalizations, and weather. This information could also include user input on the possible impact of contextual data. For example, the user could specify, “Since it's unseasonably cold, we expect higher rates of disease transmission due to decreased immune system function.” This information may give the LLM context on what might be different in the current situation from historical data.

The LLM can (directly) inform the sampling at block 306. For instance, the LLM can be used to obtain multiple candidates, together with scores that measure the feasibility of each candidate. Candidate scores can be re-interpreted as probabilities, for example by passing them through a softmax function (see block 226 of FIG. 2), or another normalizing function. As another example, a tailored LLM could be queried to determine how an unusual circumstance/situation might shift the distributions of the input parameters from historical distributions. This shifting may be done via convolution or addition, or by modulating the mean, standard deviation, or other distribution parameters. These unusual situations could be flagged by an expert or could be detected via anomaly detection from an automated input data stream such as a weather data stream.

When a Monte Carlo approach is employed, the LLM may be used to inform the PDFs that are to be sampled. The LLM could provide information on the distribution type, the distribution parameters, or individual values of the PDF. If a Monte Carlo Decision Tree is being used, the LLM could be used to weight which fork to follow in a decision tree model.

As shown in FIG. 3, the LLM could also be used to determine when a different forward model 304 should be applied (such as via direct input to the forward model block 304). In the case where there are multiple options for forward models, each with a certain probability of being used, the LLM can be used to modify the probability of using one model versus the other. For example, if there is a model for transit times on high traffic versus on low traffic days, the LLM could be used to inform the probability of using the high traffic model on the day of a mega concert when calculating the overall transit time. The LLM could also be used to check for consistency of a given forward model, by checking alignment of the prediction of the model with correlations suggested by the LLM or other criteria. Thus, if the model hypothesizes that a decrease in temperature causes less mobility but also causes faster transmission of disease, and also that greater mobility is correlated with faster spread, the system may conclude something was not consistent with that model and as a result would decrease the probability of selecting that forward model.

Example situations that can benefit from the above approach include transit times, climate risk, contagion spreading, insurance risk, etc. The following discussion provides several exemplary use cases.

### Transit Time Planning

In a transit time planning situation, because of variable delays at intersections, traffic, and loading/unloading times, simulations to calculate an expected arrival time can draw from probability distributions of these individual delays and return a probability distribution for the overall transit time. By way of example, assume a user wants to model the estimated arrival time for a cargo ship at the Port of Rotterdam. In this scenario, the ship firsts transit the Atlantic and then stops at the Port of Hamburg before arriving at the Port of Rotterdam. The user can use a stochastic model that has historical data of transit times for the individual legs of the voyage and for port delay time at the Port of Hamburg.

In this situation, the system has an LLM that was trained on a generic corpus of text data. It is then fine-tuned on a domain-specific corpus of text data about maritime transport. It may also be fine tuned using in-context conversation text with one or more users, and through active learning in which it asks questions of users (e.g., sea captains and operations control managers) to reduce its uncertainty. It may also be able to augment any prompts using RAG with the domain-specific text corpus.

The system uses the tailored LLM (e.g., 302 in FIGS. 3A-3B) to determine the joint probability distribution between transit times and port delays (e.g., at block 308). Note that these two input parameters would be correlated since a storm can increase transit times and port delays. This joint probability distribution is sampled (e.g., at block 306) as part of a Monte Carlo simulation and distributions for the total transit time and arrival time are estimated.

In this scenario, there is a hurricane in the North Atlantic. This storm will impact both the transit time and the port delay time at Hamburg. The system gathers this contextual information as part of the prompt. This prompt may be provided by user input that there is a hurricane, or it could be obtained based on received daily weather forecast data that is provided as input to the system. The LLM 302 can adjust the joint probability distribution function, increasing the mean transit and the mean port delay times, as well as increasing the correlation between the two quantities. This adjusted jPDF is then sampled and propagated through the forward model (e.g., at block 304) to determine the probability distribution of the estimated arrival time, which may be generated as output at block 312.

Another scenario of interest is climate risk. Here, there may be many factors to evaluate, each with a corresponding level of uncertainty. The stochastic system may model the climate risk for a specific location and/or piece of infrastructure (e.g., likelihood of electric grid fault/failure, rail or airline cancellations, road closures, etc.). Rising temperatures, flood risks, wildfire risks can all contribute to overall climate risk at a given location. Modeling overall climate risk via an LLM can therefore draw from probability distributions for each of these quantities to feed into an overall probabilistic risk assessment.

A further scenario involves contagion spreading, in particular how infectious diseases may spread throughout a population depends on a lot of probabilistic events. Factors of interest can include who visits what types of public areas (e.g., parks, malls, etc.), overall levels of transmission at those areas (e.g., for indoor versus outdoor places), and treatment impacts. Each of these factors can have an associated level of uncertainty. To simulate overall spread of an infectious disease, it can be useful to incorporate all these individual sources of uncertainty. The LLM approaches discussed above can be used to estimate the PDFs, inform the forward model(s) and/or affect what samples are used from the distributions.

A further scenario involves financial forecasts. In particular, the forecasted performance and volatility of a financial portfolio depends on many probabilistic events. Factors of interest could include macroeconomic trends, regulatory changes, and/or geopolitical events. To simulate overall portfolio performance and volatility, it can be useful to incorporate all these individual sources of uncertainty and their impacts into the forecast model. The LLM could be used to estimate the PDFs and/or inform the forward model(s).

### Example Computing Architecture

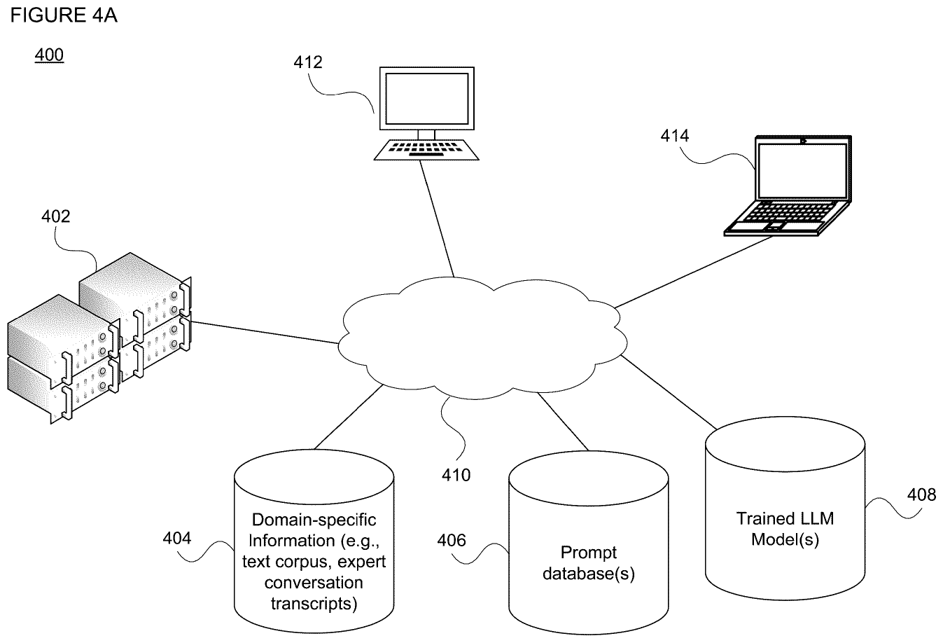

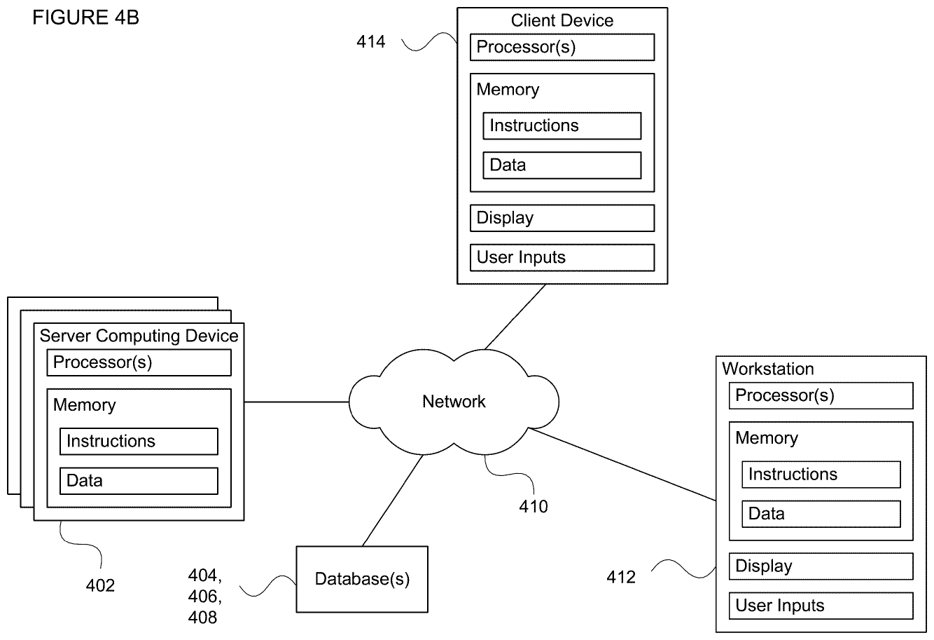

The LLMs employed for stochastic modeling and/or inverse design, according to aspects of the technology, may be implemented using one or more tensor processing units (TPUs), CPUs or other computing in accordance with the features disclosed herein. One example computing architecture is shown in FIG. 4A and FIG. 4B. In particular, FIG. 4A and FIG. 4B are pictorial and functional diagrams, respectively, of an example system 400 that includes a plurality of computing devices and databases connected via a network. For instance, computing device(s) 402 may be implemented as a cloud-based server system. Databases 404, 406 and 408 may store, e.g., training inputs (e.g., domain-specific text corpuses, transcripts of expert question-and-answer sessions, etc.), prompt information, baseline and/or trained LLM models, etc. While three databases are shown, such information may be stored in one or more databases that maintain different types of information. The server system may access the databases via network 410. Client devices may include one or more of a desktop computer 412 (e.g., a workstation) and a laptop or tablet PC 414, although other types of client devices may be employed.

As shown in FIG. 4B, each of the computing devices 402 and 412-414 may include one or more processors, memory, data and instructions. The memory stores information accessible by the one or more processors, including instructions and data (e.g., LLM models) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphic processing units (GPUs), etc. Alternatively, each processor may be a dedicated device such as an ASIC or other hardware-based processor. Although FIG. 4B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 402. Accordingly, references to a processor or computing device will be understood to include references to a collection of processors or computing devices or memories that may or may not operate in parallel.

Moreover, reference to “one or more processors” herein includes situations where a set of processors may be configured to perform one or more operations. Any combination of such a set of processors may perform individual operations or a group of operations. This may include two or more CPUs, TPUs or GPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The input data, such as domain-specific text corpuses, design problem input parameters, and/or stochastic model input probability distributions, may be operated on by one or more trained LLM models using a selected prompt (e.g., an engineered prompt). The client devices may utilize such information in various apps or other programs to perform inverse design, design space search, predictive modeling, etc.

The computing devices may include all of the components normally used in connection with a computing device such as the processor and memory described above as well as a user interface subsystem for receiving audio and/or other input from a user and presenting information to the user (e.g., text, imagery, videos and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users. This enabled the client device to present information to a user, as well as to perform question-answering such as in a domain expert in-context conversation for active learning.

The user-related computing devices (e.g., 412-414) may communicate with a back-end computing system (e.g., server 402) via one or more networks, such as network 410. The network 410, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 402 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 402 may include one or more server computing devices that are capable of communicating with any of the computing devices 412-414 via the network 410.

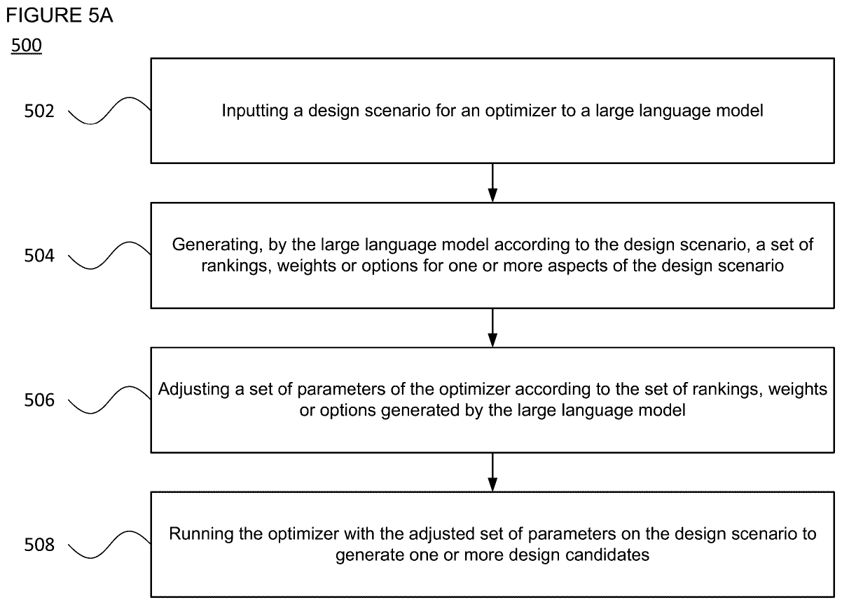

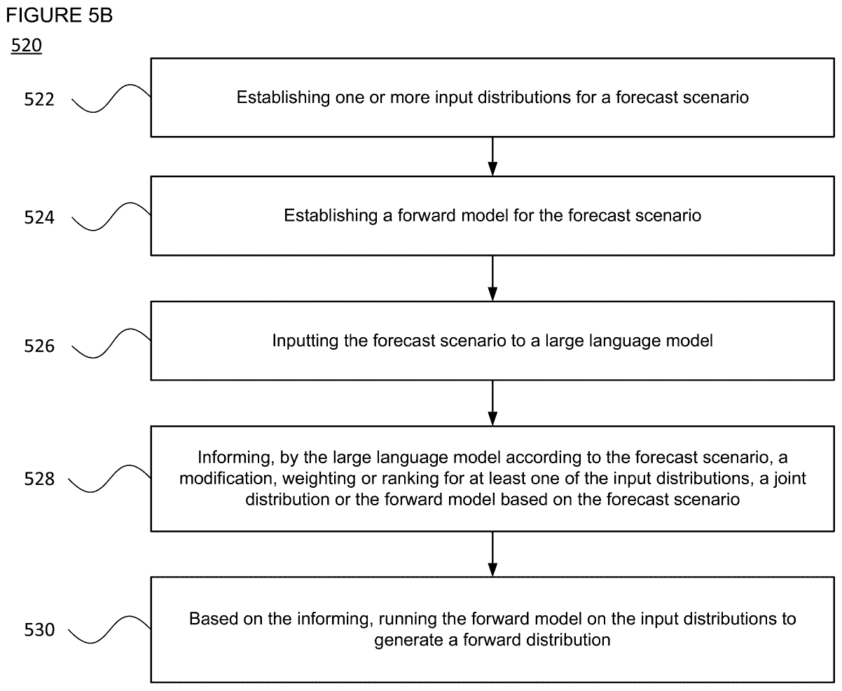

FIG. 5A illustrates a method 500 for inverse design in accordance with aspects of the technology. At block 502, a design scenario for an optimizer is input to a large language model. At block 504, the method includes generating, by the large language model according to the design scenario, a set of rankings or weights for one or more aspects of the design scenario. At block 506, the method includes adjusting a set of parameters of the optimizer according to the set of rankings or weights generated by the large language model. And at block 508, the method includes running the optimizer with the adjusted set of parameters on the design scenario to generate one or more design candidates. This process may be done one or more times, in particular by repeating the generating and adjusting operations.

FIG. 5B illustrates a method 500 for stochastic predictive modeling in accordance with aspects of the technology. At block 522, the method includes establishing one or more input distributions for a forecast scenario, and at block 524 it includes establishing a forward model for the forecast scenario. These may be done in a different order or concurrently. At block 526, the method includes inputting the forecast scenario to a large language model. At block 528, the method includes informing, by the large language model according to the forecast scenario, a modification, weighting or ranking for at least one of the input distributions, a joint input distribution, or the forward model based on the forecast scenario. Then, at block 530, based on the informing, the method includes running the forward model on the input distributions to generate a forward distribution. This process may be done one or more times, in particular by repeating the informing and running operations.

The features and methodology described herein may provide inverse design solutions when available information is sparse or uncertain. Leveraging a large language model to adjust parameters of a task-specific optimizer can yield better results than using either the LLM or the optimizer alone. Similarly, the features and methodology of this technology may provide stochastic predictive modeling for novel situations where historical data is sparse or seems irrelevant. Leveraging a large language model to adjust input distributions and/or a forward model can yield better results than using either the LLM or the forward model alone.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined herein.

1. A computer-implemented method for inverse design, comprising:
inputting a design scenario for an optimizer to a large language model;
generating, by the large language model according to the design scenario, a set of rankings, weights or options for one or more aspects of the design scenario;
adjusting a set of parameters or generating a set of outputs of the optimizer according to the set of rankings, weights or options generated by the large language model; and
running the optimizer with the adjusted set of parameters on the design scenario to generate one or more design candidates.

2. The computer-implemented method for inverse design of claim 1, wherein:
the optimizer is associated with a plurality of forward models;
generating the set of rankings, weights or options for one or more aspects of the design scenario includes ranking or weighting each of the forward models; and
running the optimizer includes selecting at least one of the forward models according to the ranking or weighting.

3. The computer-implemented method for inverse design of claim 1, wherein generating the set of rankings, weights or options for the one or more aspects of the design scenario includes tailoring the large language model according to a specific corpus of information corresponding to the design scenario.

4. The computer-implemented method for inverse design of claim 3, wherein the tailoring includes performing active learning with the specific corpus of information.

5. The computer-implemented method for inverse design of claim 3, wherein the tailoring includes performing active learning via a domain expert conversation.

6. The computer-implemented method for inverse design of claim 1, wherein:
the one or more design candidates comprise a set of design candidates, and the method further comprises ranking or filtering the set of design candidates.

7. The computer-implemented method for inverse design of claim 1, further comprising the large language mode either:
selecting a given one of the one or more design candidates; or
outputting the given design candidate as a result of the inverse design.

8. The computer-implemented method for inverse design of claim 1, wherein:
the optimizer is associated with a plurality of forward models; and
the large language model informing which ones of the plurality of forward models to use for the inverse design.

9. A processing system configured to perform inverse design, the processing system comprising:
memory configured to store one or more design candidates; and
one or more processors operatively coupled to the memory, the one or more processors being configured to:
input a design scenario for an optimizer to a large language model;
generate, employing the large language model according to the design scenario, a set of rankings, weights or options for one or more aspects of the design scenario;
adjust a set of parameters or generating a set of outputs of the optimizer according to the set of rankings, weights or options generated while employing the large language model; and
run the optimizer with the adjusted set of parameters on the design scenario to generate the one or more design candidates.

10. The processing system of claim 9, wherein:
the optimizer is associated with a plurality of forward models;
generation of the set of rankings, weights or options for one or more aspects of the design scenario includes ranking or weighting each of the forward models; and
the optimizer is run to include selection of at least one of the forward models according to the ranking or weighting.

11. The processing system of claim 9, wherein generation of the set of rankings, weights or options for the one or more aspects of the design scenario includes the large language model being tailored according to a specific corpus of information corresponding to the design scenario.

12. The processing system of claim 11, wherein the tailoring includes performance of active learning via a domain expert conversation.

13. The processing system of claim 9, wherein:
the one or more design candidates comprise a set of design candidates, and the processing system is further configured to rank or filter the set of design candidates.

14. A computer-implemented method for stochastic predictive modeling, comprising:
establishing one or more input distributions for a forecast scenario;
establishing a forward model for the forecast scenario;
inputting the forecast scenario to a large language model;
informing, by the large language model according to the forecast scenario, a modification, weighting or ranking for at least one of the input distributions, a joint input distribution or the forward model based on the forecast scenario; and
based on the informing, running the forward model on the input distributions to generate a forward distribution.

15. The computer-implemented method for stochastic predictive modeling of claim 14, wherein running the forward model includes sampling from the input distributions and applying the sampling to the forward model.

16. The computer-implemented method for stochastic predictive modeling of claim 15, wherein the sampling is informed by the large language model.

17. The computer-implemented method for stochastic predictive modeling of claim 14, wherein informing the modification, weighting or ranking is done by shifting at least one of the one or more input distributions.

18. The computer-implemented method for stochastic predictive modeling of claim 14, wherein informing the modification, weighting or ranking by the large language model includes the large language mode indicating a distribution type, one or more distribution parameters, or individual values of a probability distribution function.

19. A processing system configured to perform stochastic predictive modeling, the processing system comprising:
memory configured to store at least one of a forecast scenario or a forward distribution; and
one or more processors operatively coupled to the memory, the one or more processors being configured to:
establish one or more input distributions for the forecast scenario;
establish a forward model for the forecast scenario;
input the forecast scenario to a large language model;
inform, by employing the large language model according to the forecast scenario, a modification, weighting or ranking for at least one of the input distributions, a joint input distribution or the forward model based on the forecast scenario; and
based on the inform the modification, run the forward model on the input distributions to generate the forward distribution.

20. The processing system of claim 19, wherein the forward model is run to includes sampling from the input distributions and application of the sampling to the forward model.
